(19) United States
(12) Patent Application Publication
(10) Pub. No.: US 2024/0074500 A1
(43) Pub. Date: Mar. 7, 2024

(54) HEATER ASSEMBLY

(71) Applicant: Philip Morris Products S.A., Neuchatel (CH)

(72) Inventors: Rui Nuno BATISTA, Morges (CH); Edward KIERNAN, La Croix-sur-Lutry (CH); Ivan PRESTIA, Calderara di Reno (IT)

(73) Assignee: Philip Morris Products S.A., Neuchatel (CH)

(21) Appl. No.: 18/261,338

(22) PCT Filed: Jan. 14, 2022
(86) PCT No.: PCT/EP2022/050788

§ 371 Date: Jul. 13, 2023

(30) Foreign Application Priority Data
Jan. 20, 2021 (EP) 21152506.8

(51) Int. Cl. A24F 40/46; A24F 40/20; H05B 3/06

(52) U.S. Cl. CPC A24F 40/46; A24F 40/20; H05B 3/06; H05B 2203/016

(57) ABSTRACT

A heater assembly couplable to an aerosol-generating device body to form an aerosol-generating device is provided, the heater assembly including a heating element mount; a heating element rotatably coupled to the mount and configured to penetrate an aerosol-generating article; and a heater assembly rotation resistance mechanism configured to resist rotation of the element in a first direction relative to the mount, limit rotation of the element in the first direction relative to the mount up to a threshold torque applied to the element, and allow further rotation of the element when a torque applied to the element exceeds the threshold torque. An aerosol-generating device is also provided, including an aerosol-generating device body and a heater assembly coupled to the body, the assembly including a heating element configured to penetrate the article and to rotate relative to the mount of the device; and a rotation resistance mechanism.

The present disclosure relates to a heater assembly. In particular, the present disclosure relates to a heater assembly couplable to an aerosol-generating device body to form an aerosol-generating device. The present disclosure also relates to an aerosol-generating device comprising the heater assembly.

In some known aerosol-generating systems, an aerosol-generating device interacts with an aerosol-forming substrate in order to generate an aerosol. In some of these systems, the device comprises a heater assembly with a heating element. The heating element is configured to penetrate the aerosol-forming substrate and heat the aerosol-forming substrate from within in order to generate an aerosol. This arrangement, in which the aerosol-forming substrate is in direct contact with the heating element in use, can be an efficient way to produce an aerosol. However, this arrangement can also lead to material from the aerosol-forming substrate being adhered to, or otherwise deposited on, the heating element. Thus, with arrangements such as this, it can be necessary for a user to occasionally clean the heating element in order to prevent a build-up of aerosol-forming substrate material on the heating element.

A typical way to clean the heating element of an aerosol-generating device would involve using a brush or other cleaning tool to scrape or otherwise remove material from the heating element. During such cleaning, a torque may be applied to the heating element as the brush or other cleaning tool contacts the heating element. This torque may result in the heating element experiencing a shear force. Such a force can lead to the heating element breaking. A similar torque may be applied to the heating element, and may also cause the heating element to break, when the heating element is being engaged with, or being disengaged from, the aerosol-generating article. A heating element in the form of a thin blade may be particularly prone to breaking because such a heating element can break from the application of a relatively small torque.

It is an object of the invention to provide a heater assembly having a heating element which is less likely to break, for example when experiencing a shear force due to the application of a torque to the heating element.

According to a first aspect of the present disclosure, there is provided a heater assembly. The heater assembly may be for use in an aerosol-generating device. The heater assembly may be couplable to an aerosol-generating device body. Coupling the heater assembly to the aerosol-generating device body may form the aerosol-generating device. The heater assembly may comprise a heating element. The heating element may be configured to penetrate an aerosol-generating article. The heating element may be configured to couple, for example rotatably couple, to a heating element mount.

Advantageously, the heating element being configured to rotatably couple to a heating element mount may allow the heating element to rotate relative to the heating element mount, rather than breaking, when a torque is applied to the heating element.

The heater assembly may be releasably couplable to the aerosol-generating device body. Advantageously, this may allow a user to uncouple the heater assembly from the device body when desired, for example in order to clean the heating element.

The heating element may be rotatably coupled to the heating element mount. Optionally, the heating element may be directly or indirectly mounted on the heating element mount. The heater assembly may comprise the heating element mount. Advantageously, this may allow the heating element to rotate relative to another component of the heater assembly. This may mean that the risk of the heating element breaking is reduced even when the heater assembly is not coupled to the device body.

Whilst coupled to the aerosol-generating device body, the heating element may be rotatable relative to the device body, or a component of the device body. The device body may comprise the heating element mount. The heater assembly may be rotatably couplable to the heating element mount of the device body. Advantageously, this may allow a user to hold the device body while cleaning the heating element, whilst still allowing the heating element or entire heater assembly to rotate when a torque is applied to the heating element.

The heating element may have a length. The length of the heating element may define a longitudinal axis. The length may be at least 5 or 10 millimetres. The length may be less than 100 or 50 millimetres. The heating element may have a width. The width may be at least 0.5, 1, 2, 3, or 5 millimetres. The width may be less than 5, 3, or 2 millimetres. The heating element may have a depth. The depth may be at least 0.1 or 0.2 millimetres. The depth may be less than 5, 3, 2, 1, or 0.5 millimetres. Each of the length, the width, and the depth may be mutually perpendicular. The length may be greater, for example at least 50, 100, 200, 500, or 1000% greater than the depth. The width may be greater, for example at least 50, 100, 200, or 500% greater than the depth. The length may be greater, for example at least 50, 100, 200, or 500% greater than the width. The heating element may be substantially planar. The heating element may comprise a blade, such as a substantially flat blade. Advantageously, such a heating element may more easily penetrate an aerosol-forming substrate. In addition, such a heating element may be less likely to form a large cavity within the aerosol-forming substrate, and may therefore me less likely to lead to material of the aerosol-forming substrate falling into the device body when the aerosol-forming substrate is removed from contact with the aerosol-forming substrate.

The heating element may be rotatable in one or both of a first direction and a second direction opposite to the first direction relative to the heating element mount when the heating element is rotatably coupled to the heating element mount. The first direction and the second direction may be clockwise and anti-clockwise directions, respectively. The heating element may be able to rotate at least 180, 270, 360, 450, 540, or 720 degrees in one or both of the first direction and the second direction opposite to the first direction when the heating element is rotatably coupled to the heating element mount. The heating element may be able to rotate indefinitely in one or both of a first direction and a second direction opposite to the first direction when the heating element is rotatably coupled to the heating element mount. Advantageously, the lack of a point beyond which the heating element cannot rotate may allow the heating element to continue rotating in response to torque applied to the heating element, rather than breaking due to excessive shear forces developing in the heating element.

The heating element may be locatable in one or more stable orientations. The term “stable orientation” may refer to an orientation or angular position of the heating element in which the net torque applied to the heating element is zero. In a stable orientation, the heating element may be unable to rotate, or may remain stationary, relative to the heating element mount unless acted upon by force external to the aerosol-generating device, such as a force applied by a user.

A stable orientation may refer to a single angular position of the heating element relative to the heating element mount. Alternatively, a stable orientation may span a continuous range of angular positions of the heating element relative to the heating element mount.

In a stable orientation, rotation of the heating element relative to the heating element mount in one or both of a first direction and a second direction opposite to the first direction may be limited, for example to less than 90, 60, 45, 20 or 10 degrees, unless a torque of magnitude equal to or greater than a threshold torque is applied to the heating element. This threshold torque may be between 0.0129 and 8.050 Newton metres, or between 0.634 and 5.070 Newton metres, or between 1.410 and 3.980 Newton metres

In a stable orientation, rotation of the heating element relative to the heating element mount by less than a first predetermined angle in a first direction, and preferably also by less than a second predetermined angle in a second direction opposing the first direction, may be substantially unresisted.

In a stable orientation, rotation of the heating element relative to the heating element mount by more than a first predetermined angle in a first direction, and preferably also by more than a second predetermined angle in a second direction opposing the first direction, may be resisted, for example by a rotation resistance mechanism or heater assembly rotation resistance mechanism as described later.

One or both of the first and second predetermined angles of rotation may be less than 90, 60, 45, 20 or 10 degrees of rotation. One or both of the first and second predetermined angles of rotation may be 0 degrees, for example where the stable orientation is a single angular position. The heating element may be able to rotate out of the stable orientation in which it is located, for example if a torque applied to the blade exceeds a threshold torque. This threshold torque may be a torque between 0.0129 and 8.050 Newton metres, or between 0.634 and 5.070 Newton metres, or between 1.410 and 3.980 Newton metres. In this manner, in a stable orientation, a relatively small torque may be applied to the heating element, for example while cleaning the heating element, without the heating element rotating. Advantageously, this may make cleaning the heating element easier. But when a relatively large torque is applied to the heating element, such as a torque which could result in shear forces in the heating element sufficient to break the heating element, the heating element may rotate. This may advantageously result in a reduction of the torque applied to the heating element. This may advantageously warn a user that an excessive torque was previously being applied to the heating element.

The aerosol-generating device, for example the heater assembly or the aerosol-generating device body, may comprise a first biasing means for biasing the heating element towards a first stable orientation. The aerosol-generating device, for example the heater assembly or the aerosol-generating device body, may comprise a second biasing means for biasing the heating element towards a second stable orientation different to the first stable orientation. One or both of the first and second biasing means may comprise a spring. The first and second biasing means may be the same biasing means.

The heating element may be locatable in at least two, three, five, seven, or ten stable orientations, for example by rotation relative to the heating element mount. Advantageously, this may mean that there are multiple orientations of the heating element in which cleaning the heating element is easier.

The heater assembly may comprise a rotary electrical interface for connecting the heating element to a power supply. The device body may comprise a second rotary electrical interface corresponding to the rotary electrical interface of the heater assembly. The rotary electrical interface and the second rotary electrical interface may together form a rotary electrical connection for connecting the heating element to the power supply. The rotary electrical connection may comprise a slip ring. The rotary electrical connection may be configured to maintain an electrical connection between the heating element and the power supply as the heating element rotates relative to the heating element mount. Thus, advantageously, the rotary electrical interface of the heater assembly may form part of a rotary electrical connection which allows the electrical connection between the heating element and the power supply to be maintained as the heating element rotates relative to the heating element mount.

The rotary electrical interface may be able to rotate at least 180, 360, or 720 degrees in one or both of a first direction and a second direction opposite to the first direction when the heating element is rotatably coupled to the heating element mount. The rotary electrical interface may be able to rotate indefinitely in one or both of a first direction and a second direction opposite to the first direction when the heating element is rotatably coupled to the heating element mount.

The aerosol-generating device body may comprise the power supply. Coupling the heater assembly to the device body may connect the heating element to the power supply of the device body. Coupling the heating element to the heating element mount may connect the heating element to the power supply of the device body. Advantageously, this may mean that fewer actions are required in order to form an aerosol-generating device which is ready for use.

The heating element may comprise an electrically resistive track. In use, a current may be passed through the electrically resistive track to increase a temperature of the track. In use, this may be used to heat the aerosol-forming substrate.

The track may comprise a first electrical terminal and a second electrical terminal. The rotary electrical interface may comprise the first electrical terminal and the second electrical terminal.

The heating element may comprise a susceptor material. The susceptor material of the heating element may be configured to be inductively heated. For example, the aerosol-generating device body may comprise an inductor, such as an inductor coil, and a power source. The power source may be configured to pass an alternating current through the inductor such that the inductor generates a fluctuating electromagnetic field. The device body may be configured such that, when the heater assembly is coupled to the device body, the heating element of the heater assembly is located within the fluctuating electromagnetic field. This, in turn, may generate eddy currents and hysteresis losses in the susceptor material. This may cause the susceptor material to heat up. Thus, the power source and the inductor of the device body may be configured to inductively heat the susceptor material of the heating element in use.

The susceptor material may be, or may comprise, any material that can be inductively heated to a temperature sufficient to generate an aerosol from the aerosol-forming substrate. Preferred susceptor materials may be heated to a temperature in excess of 50, 100, 150, 200, 250, 300, 350, or 400 degrees Celsius. Preferred susceptor materials may comprise a metal or carbon or both a metal and carbon. A preferred susceptor material may comprise a ferromagnetic material, for example ferritic iron, or a ferromagnetic steel or stainless steel. A suitable susceptor material may be, or comprise, one or more of graphite, molybdenum, silicon carbide, stainless steels, niobium, and aluminium. Preferred susceptor materials may comprise, or be formed from, 400 series stainless steels, for example grade 410, or grade 420, or grade 430 stainless steel. Different materials will dissipate different amounts of energy when positioned within electromagnetic fields having similar values of frequency and field strength. Thus, parameters of the susceptor material such as material type and size may be altered to provide a desired power dissipation within a known electromagnetic field.

The heater assembly may comprise a heater assembly rotation resistance mechanism. The heater assembly rotation resistance mechanism may be configured to resist rotation of the heating element in a first direction relative to the heating element mount. The heater assembly rotation resistance mechanism may be configured to resist rotation of the heating element in a second direction, opposite to the first direction, relative to the heating element mount. Advantageously, resisting rotation of the heating element may prevent the heating element from substantially freely rotating when a small torque is applied to the heating element, for example during cleaning. This may make it easier to clean the heating element.

According to a second aspect of the present disclosure, there is provided an aerosol-generating device. The aerosol-generating device may comprise an aerosol-generating device body. The aerosol-generating device body may comprise any features described above in relation to an aerosol-generating device body. The aerosol-generating device may comprise a heater assembly. The heater assembly may comprise any of the features described above in relation to a heater assembly. The heater assembly may be a heater assembly according to the first aspect.

Unless otherwise specified, features described below in relation to the aerosol-generating device refer to the aerosol-generating device when the heater assembly is coupled to the aerosol-generating device body.

As explained above, the aerosol-generating device body may comprise a second rotary electrical interface corresponding to the rotary electrical interface of the heater assembly. The rotary electrical interface and the second rotary electrical interface may together form a rotary electrical connection for connecting the heating element to a power supply, for example a power supply of the aerosol-generating device body. The rotary electrical connection may advantageously be configured to maintain an electrical connection between the heating element and the power supply as the heating element rotates relative to the heating element mount.

The second rotary electrical interface may comprise a first electrical contact surface. The second rotary electrical interface may comprise a second electrical contact surface. When the heater assembly is coupled to the aerosol-generating device body, the first electrical contact surface may be in contact with the first electrical terminal of the electrically resistive track of the heating element. When the heater assembly is coupled to the aerosol-generating device body, the second electrical contact surface may be in contact with the second electrical terminal of the electrically resistive track of the heating element. Advantageously, contact between the first electrical terminal and the first electrical contact surface, and between the second electrical terminal and the second electrical contact surface, may be used to connect the heating element of the heater assembly to the power supply of the aerosol-generating device body.

The first electrical contact surface may be substantially flat. The second electrical contact surface may comprise a closed loop of electrically conductive material. The second electrical contact surface may be spaced from the first electrical contact surface. The second electrical contact surface may encircle the first electrical contact surface or the first electrical contact surface may encircle the second electrical contact surface. As the heating element rotates relative to the heating element mount, the second electrical terminal may move relative to the second electrical contact surface, for example in a looped path along the second electrical contact surface. As the heating element rotates relative to the heating element mount, the second electrical terminal may remain in contact with the second electrical contact surface. As the heating element rotates relative to the heating element mount, the first electrical terminal may move relative to the first electrical contact surface, for example in a looped path along the first electrical contact surface. As the heating element rotates relative to the heating element mount, the first electrical terminal may remain in contact with the first electrical contact surface. Advantageously, in this manner, an electrical connection may be maintained between the heating element and the power supply as the heating element rotates.

One or both of the first electrical contact surface and the second electrical contact surface may be electrically connected to the power supply of the aerosol-generating device body by one or more wired connections.

The aerosol-generating device may comprise a rotation resistance mechanism. The rotation resistance mechanism may be configured to resist rotation of the heating element in one or both of a first direction and a second direction opposite to the first direction relative to the heating element mount. The rotation resistance mechanism may be configured to resist rotation of the heating element in one or both of a first direction and a second direction opposite to the first direction relative to the heating element mount when the heating element is located in one or more particular positions, for example one or more particular angular positions or one or more stable orientations. The rotation resistance mechanism may be, or may comprise, the heater assembly rotation resistance mechanism described in relation to the first aspect. Alternatively, the aerosol-generating device body may comprise at least a portion of the rotation resistance mechanism. Advantageously, resisting rotation of the heating element may prevent the heating element from substantially freely rotating when a relatively small torque is applied to the heating element, for example during cleaning. This may make it easier to clean the heating element.

The rotation resistance mechanism may comprise one or more ridges. The one or more ridges may be coupled to, or form part of, the heater assembly or the heating element. The rotation resistance mechanism may comprise an arm. The arm may be coupled to, or form part of, the heater assembly or the heating element. The arm may extend radially outwardly from the heating element. The arm may extend axially away from the heating element. A first portion of the arm may be offset from an axis of rotation of the heating element. The first portion of the arm may move in a looped path as the heating element rotates about the axis of rotation of heating element. The heating element may define a central, longitudinal axis. The heating element may be rotatable about the central, longitudinal axis of the heating element. The first portion of the arm may be offset from the central, longitudinal axis of the heating element. As the heating element rotates relative to the heating element mount, the arm may move over the ridge or one of the ridges. The arm may remain in contact with the ridge, or one of the ridges, as the arm moves over the ridge, or over one of the ridges. The or each ridge may be configured to resist rotation of the heating element in one or both of a first direction and a second direction opposite to the first direction relative to the heating element mount. For example, the or each ridge may be configured to resist movement of the arm over the or each ridge. As the heating element rotates relative to the heating element mount, the arm may be configured to move over each of the ridges in turn. Movement of the arm over one of the ridges may provide the resistance to the rotation of the heating element relative to the heating element mount. Advantageously, the use of an arm coupled to the heating element and a ridge over which the arm moves as the heating element rotates may allow a straightforward way to resist rotation of the heating element. In addition, this may allow straightforward adjustment of the maximum magnitude of the resistance, for example by varying the peak size of the ridge or ridges, and the angle of rotation over which the resistance is applied, for example by varying the steepness of the ridge or ridges.

The rotary electrical connection may comprise at least a portion of the rotation resistance mechanism. The rotation resistance mechanism may comprise at least a portion of the rotary electrical connection. One or more components of the rotary electrical connection may also be one or more components of the rotation resistance mechanism. Advantageously, this may minimise the number of components in the aerosol-generating device. Advantageously, this may simplify and reduce the cost of assembly and manufacture of the device compared with using separate components for the rotary electrical connection and the rotation resistance mechanism.

The second electrical contact surface may comprise the one or more ridges. The arm may comprise, or may be, the second electrical terminal. As the heating element rotates relative to the heating element mount, the second electrical terminal may move over the ridge, or one of the ridges, on the second electrical contact surface. As the heating element rotates relative to the heating element mount, the second electrical terminal may move over each of the ridges in turn. Movement of the second electrical terminal over one of the ridges may provide the resistance to the rotation of the heating element relative to the heating element mount. Advantageously, this arrangement may provide a simply way to resist rotation of the heating element relative to the heating element mount.

The or each ridge may span an angular range of at least 1, 5, 10, 20, or 50 degrees. The or each ridge may span an angular range of less than 90, 60, 45, 20 or 10 degrees.

The or each ridge may bias the heating element towards a stable orientation. The or each ridge may act as one or both of the first and second biasing means mentioned previously.

As an example of a particular rotation resistance mechanism, the second electrical contact surface may be substantially annular and the second electrical terminal may be configured to loop clockwise around the second electrical contact surface as the heating element is rotated in a clockwise direction. The second electrical contact surface may comprise four equally spaced ridges. The second, third and fourth ridges have peaks located at 90, 180, and 270 degree clockwise bearings from the peak of the first ridge. Unless specified otherwise, the term “bearing” used herein refers to a clockwise bearing and, where applicable, may be measured clockwise from a peak of a first ridge. Each ridge may span an angular range of around 10 degrees. The portions of the second electrical contact surface between the ridges may be substantially flat. Thus, the second ridge, with a peak located at a 90 degree bearing from the first ridge, begins to rise at a bearing of 85 degrees, reaches its peak at a bearing of 90 degrees, and then falls to back to a flat portion of the second electrical contact surface at a bearing of 95 degrees, the flat portion continuing until the start of the third ridge at a bearing of 175 degrees. The heating element may be initially oriented such that the second electrical terminal is located at a bearing of approximately 45 degrees. Thus, in this position, the heating element may be able to rotate substantially freely, or without much resistance, in either direction by around 40 degrees before encountering substantial resistance from the rotation resistance mechanism. If the heating element is rotated clockwise by 40 degrees to a bearing of 85 degrees, the second electrical terminal will engage with the ridge with its peak located at a bearing of 90 degrees. As the heating element is rotated further clockwise under the application of a torque to the heating element, the resistance against further clockwise rotation of the heating element will also increase. This is because a greater torque is required to move the second electrical terminal up towards the peak of the ridge located at a bearing of 90 degrees. Once the second electrical terminal reaches the peak of the ridge at a bearing of 90 degrees under an applied torque, the resistance to rotation of the heating element decreases. Thus, the heating element is allowed to rotate further in this direction and the second electrical terminal can move down beyond the peak of the ridge without substantial resistance, and possibly with aid from the downward-sloping portion of the ridge. In this sense, rotation of the heating element may be resisted by the rotation resistance mechanism up to a degree of rotation of the heating element or application of a threshold torque to the heating element, and then, beyond this degree of rotation or threshold torque, rotation may be allowed or aided by the rotation resistance mechanism.

As an alternative example of a rotation resistance mechanism, when the heater assembly is coupled to the aerosol-generating device body, the heating element may be located in a chamber defined by the device body. An arm may be coupled to the heating element and may extend radially outwardly from the heating element. An internal surface of the chamber of the device body may comprise one or more ridges extending radially inwardly towards the heating element. As the heating element rotates, radially outwardly extending arm may contact and move over the ridges. These ridges may resist rotation of the heating element in a similar manner to previously described.

When the arm, or the second electrical terminal, is located between two successive ridges, the heating element may be located in a stable orientation, as described previously. In this sense, the predetermined angle of rotation described previously may be the amount of rotation in a given direction possible before another ridge resists further rotation of the heating element in the given direction. The ridge may not continue to resist rotation of the heating element once the arm or second electrical terminal has moved beyond the peak of that ridge. In this sense, the rotation resistance mechanism, or the or each ridge of the rotation resistance mechanism, may be considered to temporarily resist rotation of the heating element. Advantageously, the second electrical contact surface comprising a plurality of ridges may provide a plurality of stable orientations in which cleaning the heating element is easier than if no stable orientations were present.

The rotation resistance mechanism may provide a non-linear resistance against rotation of the heating element, for example in one or both of the first direction and the second direction relative to the heating element mount. The rotation resistance mechanism may provide zero or substantially zero resistance to rotation through some degree of rotation of the heating element relative to the heating element mount. The rotation resistance mechanism may provide increasing resistance to rotation in response to an increasing torque applied to the heating element up to a threshold torque applied to the heating element. Once the rotation resistance mechanism begins resisting rotation of the heating element, as one or both of the heating element rotates further and the torque applied to the heating element is increased, the resistance to rotation may also increase. This may limit rotation, for example limit rotation to less than 90, 60, 45, 20 or 10 degrees, of the heating element until the applied torque reaches the threshold torque. When the torque applied to the heating element reaches or exceeds the threshold torque, the heating element may be allowed to rotate further. Where the rotation resistance mechanism comprises one or more ridges, this increasing resistance to rotation may occur as the second electrical terminal moves upwards towards a peak of a ridge. Advantageously, limiting rotation in response to small torques applied to the heating element may make cleaning the heating element easier. This is because a user may be able to apply some pressure to the heating element with a cleaning tool without the heating element rotating away from the cleaning tool by a significant amount.

This threshold torque, or any other threshold torque mentioned herein, may be between 0.0129 and 8.050 Newton metres, or between 0.634 and 5.070 Newton metres, or between 1.410 and 3.980 Newton metres.

This threshold torque, or any other threshold torque mentioned herein, may be measured using a torque measuring device. Such devices are commercially available and would be known to a person skilled in the art.

This threshold torque, or any other threshold torque mentioned herein, may be measured by engaging a torque measuring device with the heating element. A torque may be applied to the heating element using the torque measuring device. The torque applied to the heating element may be slowly increased towards the threshold torque. The torque applied to the heating element may be monitored by the torque measuring device. Once the torque applied to the heating element reaches or exceeds the threshold torque, the resistance to rotation of the heating element may decrease as explained above. At this stage, the heating element may be allowed to rotate as explained above. Thus, the torque applied to the heating element by the torque measuring device may decrease. So the torque measuring device may show that the torque applied to the heating element increases up to a maximum torque and then decreases. The threshold torque may be, or may be estimated as, equal to the maximum torque measured by the torque measuring device during this process.

As the torque applied to the heating element increases beyond the threshold torque, the resistance to rotation of the heating element may decrease. For example, beyond the threshold torque, rotation of the heating element may be temporarily aided. Where the rotation resistance mechanism comprises one or more ridges, this may occur at the point when the arm or second electrical terminal passes over the peak of the ridge. The rotation resistance mechanism may be configured such that the threshold torque is less than a torque which, if applied to a non-rotatable heating element, would be expected to break the heating element. Advantageously, this may allow a user to apply some torque to the heating element without causing significant rotation of the heating element but, once the torque applied to the heating element reaches a threshold torque, for example a threshold torque at which the heating element is at risk of breaking, the resistance to rotation of the heating element decreases and the heating element is allowed or encouraged to rotate. This rotation may result in a subsequent reduction in the torque applied to the heating element, for example as a reaction from a user who noticed the rotation of the heating element when applying the torque to the heating element whilst cleaning the heating element. In this sense, the decrease in resistance to rotation at or beyond the threshold torque may also advantageously serve as a warning to a user applying the torque to the heating element that they were applying too much torque to the heating element.

The rotation resistance mechanism may prevent or limit rotation of the heating element in the first direction, or in the second direction opposite to the first direction, relative to the heating element mount up to a first direction threshold torque applied to the heating element acting to rotate the heating element in the first direction, or up to a second direction threshold torque applied to the heating element acting to rotate the heating element in the second direction, respectively. The first direction threshold torque and the second direction threshold torque may be substantially equal in magnitude, for example where the ridges are substantially symmetrical about their peaks. Thus, the rotation resistance mechanism may prevent or limit rotation of the heating element in either of the first direction and the second direction opposite to the first direction relative to the heating element mount up to a threshold torque being applied to the heating element acting to rotate the heating element in that direction. Advantageously, this may allow the user to apply a torque to the heating element, for example while cleaning the heating element with a cleaning tool, in either direction without significantly increasing the risk of fracturing the heating element.

One or both of the first direction threshold torque and the second direction threshold torque may be between 0.0129 and 8.050 Newton metres, or between 0.634 and 5.070 Newton metres, or between 1.410 and 3.980 Newton metres.

When the torque applied to the heating element exceeds the first or second direction threshold torque, the rotation resistance mechanism may allow or encourage further rotation of the heating element in the first or second direction, respectively. Advantageously, this may allow a user to apply some torque to the heating element without causing significant rotation of the heating element but, once the torque applied to the heating element reaches a threshold torque, for example a threshold torque at which the heating element is at risk of breaking, the resistance to rotation of the heating element may decrease and the heating element may be allowed to rotate.

The aerosol-generating device body may comprise a housing. The housing may comprise a holding portion. The holding portion may be configured to be held by a user during use of the device to generate an aerosol. The aerosol-generating device may comprise a chamber. The housing may define the chamber. The chamber may be for receiving the aerosol-generating article. The heating element may be positioned at least partially within the chamber. The heating element may be configured to penetrate an aerosol-generating article received in the chamber. The heating element may be rotatable relative to at least a portion of the housing. For example, the heating element may be rotatable relative to the chamber. Alternatively, or in addition, the heating element may be rotatable relative to the holding portion of the housing.

The chamber may define a longitudinally extending cavity. The heating element may extend along a central, longitudinally extending axis of the chamber. The heating element may be rotatable about the central, longitudinally extending axis of the chamber. Advantageously, this may eliminate movement of the heating element in a circular path as the heating element rotates.

Features described in relation to the first aspect may be applicable to the second aspect of this disclosure. Features described in relation to the second aspect may be applicable to the first aspect of this disclosure.

As used herein, the term “aerosol” refers to a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, the term “aerosol-forming substrate” refers to a substrate capable of releasing volatile compounds that can form an aerosol. The volatile compounds may be released by heating the aerosol-forming substrate.

The aerosol-forming substrate may be a solid aerosol-forming substrate. The solid aerosol-forming substrate may comprise one or more of: powder, granules, pellets, shreds, strands, strips or sheets containing one or more of: herb leaf, tobacco leaf, tobacco ribs, expanded tobacco and homogenised tobacco.

The aerosol-forming substrate may comprise solid and liquid components. The aerosol-forming substrate comprise a liquid, gel or paste aerosol-forming substrate.

The aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The aerosol-forming substrate may be deposited on the entire surface of the carrier, or alternatively, may be deposited in a pattern in order to provide a non-uniform flavour delivery during use.

The aerosol-forming substrate may comprise nicotine. The aerosol-forming substrate may comprise plant-based material. The aerosol-forming substrate may comprise homogenised plant-based material. The aerosol-forming substrate may comprise tobacco. The aerosol-forming substrate may comprise a tobacco-containing material. The tobacco-containing material may contain volatile tobacco flavour compounds. These compounds may be released from the aerosol-forming substrate upon heating. The aerosol-forming substrate may comprise homogenised tobacco material. The aerosol-forming substrate may comprise other additives and ingredients, such as flavourants.

The aerosol-forming substrate may comprise homogenised tobacco material. As used herein, the term “homogenised tobacco material” refers to a material formed by agglomerating particulate tobacco.

The aerosol-forming substrate may comprise a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article.

The aerosol-forming substrate may comprise an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article. Suitable aerosol-formers are known in the art and include, but are not limited to: polyhydric alcohols, such as propylene glycol, tri-ethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. For example, the aerosol-forming substrate may comprise glycerine as the only aerosol former, or propylene glycol as the only aerosol former. Alternatively, the aerosol-forming substrate may comprise a combination of two or more aerosol formers. For example, the aerosol former component of the aerosol-forming substrate may be glycerine and propylene glycol.

As used herein, the term “aerosol-generating article” refers to an article comprising, or consisting of, an aerosol-forming substrate. An aerosol-generating article may comprise components in addition to the aerosol-forming substrate. The aerosol-generating article may be a smoking article. The aerosol-generating article may generate an aerosol that is directly inhalable into a user's lungs through the user's mouth. The aerosol-generating article may be a smoking article that generates a nicotine-containing aerosol that is directly inhalable into a user's lungs through the user's mouth. The aerosol-generating article may be in the form of a rod.

As used herein, the term “aerosol-generating device” refers to a device that interacts with an aerosol-forming substrate to generate an aerosol. An aerosol-generating device may interact with an aerosol-generating article comprising an aerosol-forming substrate, or with a cartridge holding an aerosol-forming substrate or aerosol-generating article, to generate an aerosol. The aerosol-generating device may heat the aerosol-forming substrate to facilitate release of volatile compounds from the substrate. The aerosol-generating device may be an electrically operated aerosol-generating device. The aerosol-generating device may comprise an aerosol-generating device body and a heater assembly.

As used herein, the terms “longitudinal” and “axial” are used to describe a direction between a downstream, proximal or mouth end of a component, such as an aerosol-generating device, heating element or aerosol-generating article, and an opposed, upstream or distal end of the component. A distance between proximal and distal ends of a component may be referred to as the length of the component.

As used herein, the term “radial” is used to describe a direction perpendicular to the longitudinal direction. A distance measured in the radial direction may be referred to as a width or depth.

Herein, unless specified otherwise, rotation of the heating element may refer to rotation of the heating element about the longitudinal axis of the heating element.

Herein, unless specified otherwise, rotation of the heating element may refer to rotation of the heating element relative to the heating element mount.

Herein, unless specified otherwise, a torque applied to the heating element may refer to a torque applied to the heating element in a direction so as to rotate the heating element about the longitudinal axis of the heating element, for example to rotate the heating element about the longitudinal axis of the heating element relative to the heating element mount.

The invention is defined in the claims. However, below there is provided a non-exhaustive list of non-limiting examples. Any one or more of the features of these examples may be combined with any one or more features of another example, embodiment, or aspect described herein.

Example Ex 1. A heater assembly couplable to an aerosol-generating device body to form an aerosol-generating device, the heater assembly comprising a heating element configured to penetrate an aerosol-generating article, wherein the heating element is configured to rotatably couple to a heating element mount.

Example Ex 2. A heater assembly according to example Ex 1, wherein the heater assembly comprises the heating element mount, the heating element being rotatably coupled to the heating element mount.

Example Ex 3. A heater assembly according to any preceding example, wherein the heating element has a length, a width, and a depth, each of the length, the width, and the depth being mutually perpendicular, and wherein each of the length and the width are greater than the depth.

Example Ex 4. A heater assembly according to any preceding example, wherein the heating element comprises a substantially flat blade.

Example Ex 5. A heater assembly according to any preceding example, wherein the heating element is able to rotate at least 360 degrees in a given direction when the heating element is rotatably coupled to the heating element mount.

Example Ex 6. A heater assembly according to any preceding example, wherein the heating element is rotatable relative to the heating element mount between at least two stable orientations.

Example Ex 7. A heater assembly according to any preceding example, wherein the heater assembly is releasably couplable to the aerosol-generating device body.

Example Ex 8. A heater assembly according to any preceding example, wherein the heater assembly comprises a rotary electrical interface for connecting the heating element to a power supply.

Example Ex 9. A heater assembly according to example Ex 8, wherein the rotary electrical interface is able to rotate at least 360 degrees in a given direction when the heating element is rotatably coupled to the heating element mount.

Example Ex 10. A heater assembly according to example Ex 8 or Ex 9, wherein the heating element comprises an electrically resistive track through which a current is passed in use to increase a temperature of the track.

Example Ex 11. A heater assembly according to example Ex 10, wherein the track has a first electrical terminal and a second electrical terminal.

Example Ex 12. A heater assembly according to example Ex 11, wherein the rotary electrical interface comprises the first electrical terminal and the second electrical terminal.

Example Ex 13. A heater assembly according to any preceding example, wherein the heater assembly comprises a heater assembly rotation resistance mechanism configured to resist rotation of the heating element in a first direction relative to the heating element mount.

Example Ex 14. An aerosol-generating device comprising an aerosol-generating device body and a heater assembly according to any preceding example.

Example Ex 15. An aerosol-generating device according to example Ex 14, wherein the heater assembly is a heater assembly according to any of examples Ex 8 to Ex 12 and the device body comprises a second rotary electrical interface corresponding to the rotary electrical interface of the heater assembly, the rotary electrical interface and the second rotary electrical interface together forming a rotary electrical connection for connecting the heating element to the power supply.

Example Ex 16. An aerosol-generating device according to example Ex 15, wherein the heater assembly is a heater assembly according to example Ex 11 or Ex 12 and the second rotary electrical interface comprises a first electrical contact surface in contact with the first electrical terminal, and a second electrical contact surface in contact with the second electrical terminal.

Example Ex 17. An aerosol-generating device according to example Ex 16, wherein the second electrical contact surface comprises a closed loop of electrically conductive material.

Example Ex 18. An aerosol-generating device according to example Ex 16 or 17, wherein the second electrical contact surface is spaced from, and encircles, the first electrical contact surface.

Example Ex 19. An aerosol-generating device according to any of examples Ex 16 to Ex 18, wherein, as the heating element rotates relative to the heating element mount, the second electrical terminal moves relative to the second electrical contact surface.

Example Ex 20. An aerosol-generating device according to example Ex 19, wherein, as the heating element rotates relative to the heating element mount, the second electrical terminal moves in a looped path along the second electrical contact surface.

Example Ex 21. An aerosol-generating device according to any of examples Ex 16 to Ex 20, wherein the aerosol-generating device body comprises a power supply and one or both of the first electrical contact surface and the second electrical contact surface are electrically connected to the power supply by a wired connection.

Example Ex 22. An aerosol-generating device according to any of examples Ex 16 to Ex 21, wherein the device comprises a rotation resistance mechanism configured to resist rotation of the heating element in a first direction relative to the heating element mount.

Example Ex 23. An aerosol-generating device according to example Ex 22, wherein the second electrical contact surface comprises a ridge.

Example Ex 24. An aerosol-generating device according to example Ex 23, wherein the ridge is configured to resist rotation of the heating element in a first direction relative to the heating element mount.

Example Ex 25. An aerosol-generating device according to example Ex 23 or 24, wherein, as the heating element rotates relative to the heating element mount, the second electrical terminal moves over the ridge.

Example Ex 26. An aerosol-generating device according to any of examples Ex 14 to Ex 21, wherein the device comprises a rotation resistance mechanism configured to resist rotation of the heating element in a first direction relative to the heating element mount.

Example Ex 27. An aerosol-generating device according to example Ex 26, wherein the rotation resistance mechanism provides a non-linear resistance against rotation of the heating element in the first direction relative to the heating element mount.

Example Ex 28. An aerosol-generating device according to example Ex 26 or 27, wherein the rotation resistance mechanism provides increasing resistance to rotation of the heating element in the first direction relative to the heating element mount in response to an increasing torque applied to the heating element up to a threshold torque applied to the heating element, the threshold torque optionally being between 0.0129 and 8.050 Newton metres, or between 0.634 and 5.070 Newton metres, or between 1.410 and 3.980 Newton metres.

Example Ex 29. An aerosol-generating device according to example Ex 28, wherein, as the torque applied to the heating element increases beyond the threshold torque, the resistance to rotation of the heating element decreases.

Example Ex 30. An aerosol-generating device according to any of examples Ex 26 to Ex 29, wherein the rotation resistance mechanism prevents or limits rotation of the heating element in the first direction relative to the heating element mount up to a second threshold torque applied to the heating element, the second threshold torque optionally being between 0.0129 and 8.050 Newton metres, or between 0.634 and 5.070 Newton metres, or between 1.410 and 3.980 Newton metres.

Example Ex 31. An aerosol-generating device according to example Ex 30, wherein, when the torque applied to the heating element exceeds the second threshold torque, the rotation resistance mechanism allows rotation of the heating element.

Example Ex 32. An aerosol-generating device according to any of examples Ex 26 to Ex 31, wherein the rotation resistance mechanism is configured to resist rotation of the heating element in a second direction, opposite to the first direction, relative to the heating element mount.

Example Ex 33. An aerosol-generating device according to any of examples Ex 26 to Ex 32, wherein the rotation resistance mechanism comprises a ridge.

Example Ex 34. An aerosol-generating device according to example Ex 33, wherein the device comprises an arm and, as the heating element rotates relative to the housing, the arm is dragged over the ridge.

Example Ex 35. An aerosol-generating device according to example Ex 34, wherein the arm is coupled to, or forms part of, the heating element.

Example Ex 36. An aerosol-generating device according to any of examples Ex 14 to Ex 35, wherein the device comprises a chamber for receiving the aerosol-generating article.

Example Ex 37. An aerosol-generating device according to example Ex 36, wherein the heating element is positioned within the chamber and is configured to penetrate an aerosol-generating article received in the chamber.

Example Ex 38. An aerosol-generating device according to example Ex 36 or Ex 37, wherein the chamber defines a longitudinally extending cavity.

Example Ex 39. An aerosol-generating device according to example Ex 36, Ex 37, or Ex 38, wherein the heating element extends along a central, longitudinally extending axis of the chamber.

Example Ex 40. An aerosol-generating device according to example Ex 39, wherein the heating element is rotatable about the central, longitudinally extending axis of the chamber.

Example Ex 41. An aerosol-generating device according to any of examples Ex 36 to 40, wherein the heating element is rotatable relative to the chamber.

Examples will now be further described with reference to the figures in which:

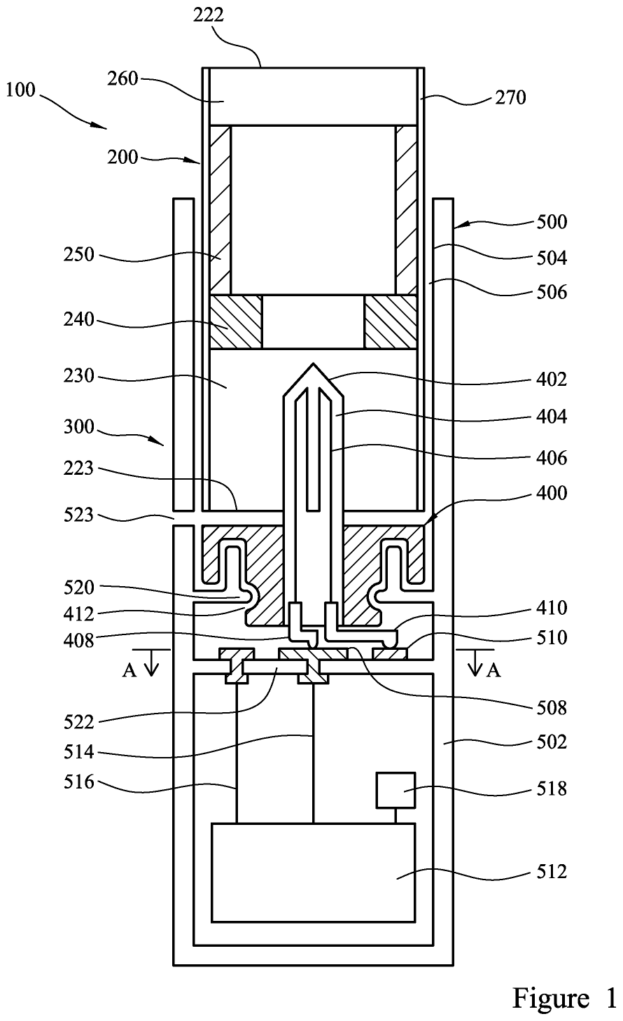

FIG. 1 shows a cross-sectional view of an aerosol-generating system comprising an aerosol-generating device having a heater assembly;

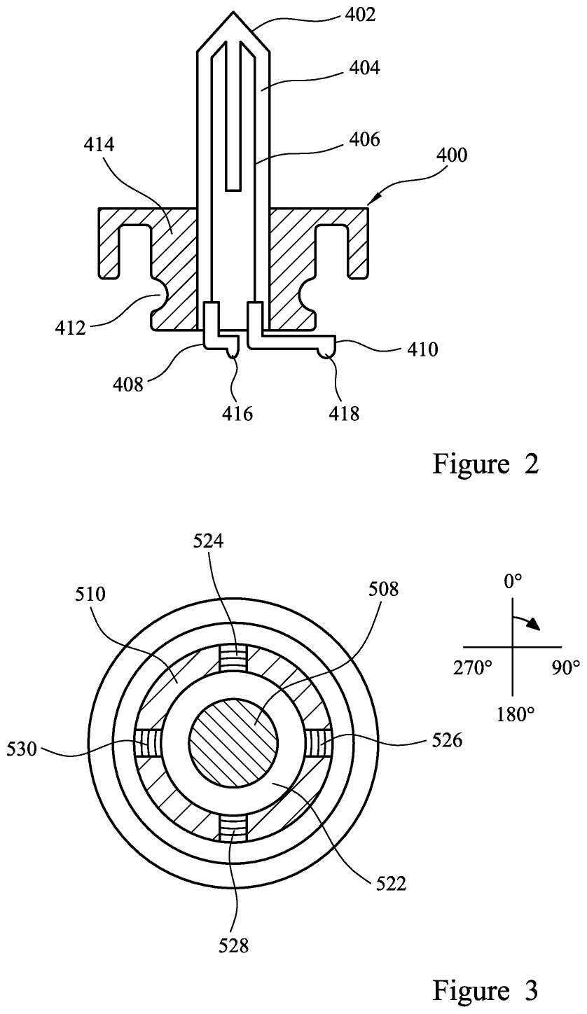

FIG. 2 shows a cross-sectional illustration of the heater assembly of the aerosol-generating device of FIG. 1;

FIG. 3 shows a top view of a portion of the aerosol-generating device of FIG. 1; and

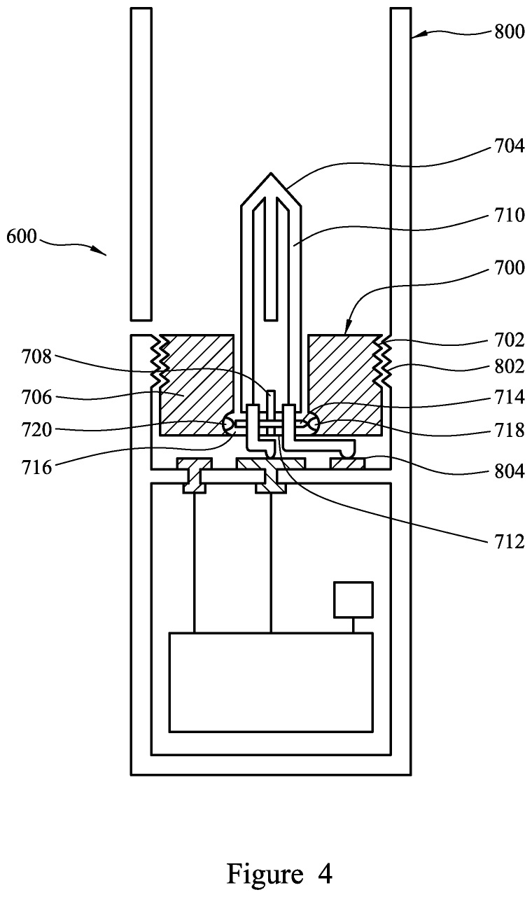

FIG. 4 shows a cross-sectional view of an alternative aerosol-generating device comprising having an alternative heater assembly.

FIG. 1 shows a cross-sectional view of an aerosol-generating system 100 comprising an aerosol-generating device 300 and an aerosol-generating article 200 for use with the aerosol-generating device 300. The device 300 comprises a heater assembly 400 coupled to an aerosol-generating device body 500.

The heater assembly 400 comprises a heating element 402. In FIG. 1, the heating element 402 is shown penetrating the aerosol-generating article 200. The heating element 402 comprises a substantially flat blade 404 having a length of around 15 millimetres, a width of around 3 millimetres, and a depth of around 0.5 millimetres. The heating element 402 also comprises an electrically resistive track 406 through which a current is passed in use to increase a temperature of the track 406. The track 406 has a first electrical terminal 408 and a second electrical terminal 410. These terminals form a rotary electrical interface for connecting the heating element 402 to a power supply of the aerosol-generating device body 500 via a second rotary electrical interface of the aerosol-generating device body 500. The heater assembly 400 is described in more detail in relation to FIG. 2.

The aerosol-generating device body 500 comprises a housing 502 configured to be held by a user in use. The device body 500 comprises a chamber 504 defining a longitudinally extending cavity 506 for receiving the aerosol-generating article 200. The aerosol-generating device body 500 also comprises a second rotary electrical interface, the second rotary electrical interface comprising a first electrical contact surface 508, and a second electrical contact surface 510. As shown in FIG. 1, when the heater assembly 400 is coupled to the aerosol-generating device body 500, the first electrical terminal 408 of the heating element 402 is in contact with the first electrical contact surface 508 and the second electrical terminal 410 of the heating element 402 is in contact with the second electrical contact surface 510. The aerosol-generating device body 500 also comprises a power supply 512. In this embodiment, the power supply 512 is a lithium-ion battery, though any suitable power supply could be used. The first rotary electrical interface of the heater assembly 400 (which comprises the first electrical terminal 408 and the second electrical terminal 410) and the second rotary electrical interface of the aerosol-generating device body 500 together form a rotary electrical connection of the aerosol-generating device 300. The rotary electrical connection connects the heating element 402 to the power supply 512 via a first wire 514 and a second wire 516. The rotary electrical connection allows the heating element 402 to rotate indefinitely in a given direction relative to the aerosol-generating device body 500 whilst maintaining the electrical connection between the track 406 of the heating element 402 and the power supply 512.

The aerosol-generating device body 500 also comprises a controller 518 for controlling the supply of power from the power supply 512 to the heating element 402.

The aerosol-generating article 200 comprises an aerosol-forming substrate 230, a hollow tube 240, a transfer section 250, and a mouthpiece filter 260. These four elements are arranged sequentially and in coaxial alignment and are assembled by a cigarette paper 270. The aerosol-generating article 200 has a mouth end 222, which a user inserts into their mouth during use, and a distal end 223 located at the opposite end of the aerosol-generating article 200 to the mouth end 222. Elements located between the mouth end 222 and the distal end 223 can be described as being upstream of the mouth end or, alternatively, downstream of the distal end. When assembled, the aerosol-generating article 200 is around 45 millimetres long and has a diameter of around 7.2 millimetres.

The aerosol-forming substrate 230 is located upstream of the hollow tube 240 and extends to the distal end 223 of the aerosol-generating article 200. The aerosol-forming substrate 230 comprises a bundle of crimped cast-leaf tobacco wrapped in a filter paper (not shown) to form a plug. The cast-leaf tobacco includes additives, including glycerine as an aerosol-former.

The hollow tube 240 is located immediately downstream of the aerosol-forming substrate 230 and is formed from a tube of cellulose acetate. The hollow tube 240 defines an aperture having a diameter of around 3 millimetres. One function of the hollow tube 240 is to locate the aerosol-forming substrate 230 towards the distal end 223 of the aerosol-generating article 200 so that it can be penetrated by the heating element 402, as shown in FIG. 1. The hollow tube 240 acts to prevent the aerosol-forming substrate 230 from being forced along the aerosol-generating article 200 towards the mouth end 222 when the heating element 402 is inserted into the aerosol-forming substrate 230.

The transfer section 250 comprises a thin-walled tube of around 18 millimetres in length. The transfer section 250 allows volatile substances released from the aerosol-forming substrate 230 to pass along the aerosol-generating article 200 towards the mouth end 222. In use, volatile compounds released from the aerosol-forming substrate 230 may cool within the transfer section 250 to form an aerosol.

The mouthpiece filter 260 is a conventional mouthpiece filter formed from cellulose acetate, and has a length of around 7.5 millimetres.

The four elements identified above are assembled by being tightly wrapped within the cigarette paper 270. The cigarette paper 270 in this specific embodiment is a conventional cigarette paper. The cigarette paper 270 may be a porous material with a non-isotropic structure comprising cellulose fibres (crisscrosses of fibres, interlinked by H-bonds) and fillers. The filler agent may be CaCO3 and the burning agents can be one or more of the following: K/Na citrate, Na acetate, MAP (mono-ammonium phosphate), DSP (di-sodium phosphate). The final composition per square meter may be approximately 25 grams fibre+10 grams Calcium carbonate+0.2 grams burning additive. The porosity of the paper may be between 0 and 120 coresta. The interface between the paper and each of the elements locates the elements in the aerosol-generating article 200.

Although a specific aerosol-generating article 200 has been described here, it should be clear to one of ordinary skill in the art that many other aerosol-generating articles are suitable for use with this invention.

Prior to use, the aerosol-generating device 300 is assembled by coupling the heater assembly 400 to the aerosol-generating device body 500. In this embodiment, the heater assembly 400 is lowered into the chamber 504 of the device body 500 and releasably coupled to the device body 500 using a snap-fit connection, though any suitable type of coupling could be used. In this embodiment, the snap-fit connection is between an annular protrusion 520 of the device body 500 and an annular recess 412 in the heater assembly 400.

In this embodiment, the aerosol-generating device body 500 comprises a heating element mount 522 on which the second rotary electrical interface is located. When the heater assembly 400 is coupled to the device body 500 via the snap-fit connection, the heating element 402 is located centrally in the chamber 504 and is rotatable about a central, longitudinally-extending axis of the chamber 504. Thus, the heater assembly 400 is able to rotate relative to the heating element mount 522 of the aerosol-generating device body 500 and may be described as being rotatably coupled to the heating element mount 522 of the aerosol-generating device body 500.

In use, a user inserts the aerosol-generating article 200 into the chamber 504 of the device body 500. This causes the heating element 402 to penetrate the aerosol-generating article 200, and places the heating element 402 in contact with the aerosol-forming substrate 230 of the aerosol-generating article 200. Then, a user presses a button (not shown) on the device body 500. This causes the controller 518 to send a signal to the power supply 512 and, in turn, causes the power supply 512 to pass an electrical current through the electrically resistive track 406 on the heating element 402, via the first and second wires 514, 516, the rotary electrical connection, and the first and second electrical terminals 408, 410. This current resistively heats up the track 406 to around 300 degrees Celsius. This heats up the aerosol-forming substrate 230 and causes volatile substances in the aerosol-forming substrate 230 to be released.

As a user draws on the mouth end 222 of the aerosol-generating article 200, air is drawn through an air inlet 523 of the aerosol-generating device body 500, and into the aerosol-generating article 200. This air flow carries the volatile substances released from the aerosol-forming substrate 230 through the aerosol-generating article 200. These compounds pass sequentially through the hollow tube 240, transfer section 250, and mouthpiece filter 260 of the aerosol-generating article. As the compounds cool, they condense to form an aerosol. The aerosol exits the aerosol-generating article 200 through the mouth end 222 of the aerosol-generating article 200 and enters the mouth of the user.

FIG. 2 shows a cross-sectional illustration of the heater assembly 400 of the aerosol-generating device of FIG. 1.

The heating element 402 is formed by depositing the electrically resistive track 406 on the blade 404 and then coating the track 406 and blade 404 in a protective coating. The protective coating protects the track 406 from being scratched or removed from the blade 404. In this embodiment, the track 406 is formed from a platinum alloy, the blade 404 is formed from zirconium, and the protective coating is formed from glass.

The heater assembly 400 comprises a body portion 414. In this embodiment, the body portion 414 is fixed to the heating element 402. As such, in use, the heating element 402 and the body portion 414 may rotate together. The body portion 414 is formed from a polymer and defines the annular recess 412 of the heater assembly 400.

As shown in FIG. 2, the first electrical terminal 408 comprises a portion in contact with the electrically resistive track 406, a portion extending in a radial direction, and a first electrical terminal contact portion 416 extending in an axial direction for contacting the first electrical contact surface 508 of the device body 500 shown in FIG. 1. Similarly, the second electrical terminal 410 comprises a portion in contact with the electrically resistive track 406, a portion extending in a radial direction, and a second electrical terminal contact portion 418 extending in an axial direction for contacting the second electrical contact surface 510 of the device body 500 shown in FIG. 1.

FIG. 3 shows a top view of a portion of the aerosol-generating device of FIG. 1. Specifically, FIG. 3 shows the view A-A indicated in FIG. 1.

In FIG. 3, the second rotary electrical interface of the aerosol-generating device body can be seen. The second rotary electrical interface comprises the first electrical contact surface 508 and the second electrical contact surface 510. The first electrical contact surface 508 comprises a flat, circular surface of electrically conductive material. The second electrical contact surface 510 comprises a closed, annular loop of electrically conductive material. The second electrical contact surface 510 is spaced from, and encircles, the first electrical contact surface 508.

The second electrical contact surface 510 comprises a first ridge 524, a second ridge 526, a third ridge 528, and a fourth ridge 530. These four ridges are equally spaced from each other around the annular, second electrical contact surface 510. When looking at FIG. 3, each ridge rises up, out of the page. In this embodiment, the steepness and peak height of each of the four ridges is identical.

When the heater assembly 400 is coupled to the aerosol-generating device body 500, as shown in FIG. 1, as the heating element 402 rotates relative to the heating element mount 522, the first electrical terminal 408 remains in contact with the first electrical contact surface 508, and the second electrical terminal 410 moves in a looped path along the second electrical contact surface 510.

After consumption of one or more aerosol-generating articles, it may be desirable to clean the heating element 402, for example to remove residue from an aerosol-forming substrate adhered to the heating element 402. This may be done by inserting a cleaning brush into the chamber 504 of the device body 500 and rubbing the cleaning brush against the heating element 402. During such cleaning, or during other interactions with the heating element 402 such as inserting the heating element 402 into an aerosol-generating article, a torque may be applied to the heating element 402. Such a torque may act to rotate the heating element 402 about its longitudinal axis. If the heating element 402 were fixed in position, such an applied torque could break the heating element 402 due to the resulting shear force in the heating element 402. However, in this embodiment, the heating element 402 is rotatable about its central axis, which aligns with the central axis of the chamber 504, relative to the aerosol-generating device body 500.

As shown in FIG. 3, the second ridge 526, the third ridge 528, and the fourth ridge 530 have peaks located at 90, 180, and 270 degree bearings clockwise from the peak of the first ridge 524, respectively. The axes included on the right-hand-side of FIG. 3 indicate the bearings of each of the ridges. Each ridge spans an angular range of around 10 degrees. Thus, for the second ridge 526 with a peak located at a 90 degree bearing clockwise from the first ridge 524, the ridge begins to rise at a bearing of 85 degrees, reaches its peak at a bearing of 90 degrees, and then falls to a valley (or substantially flat surface of the second electrical contact surface 510) at a bearing of 95 degrees, the valley (or substantially flat surface) continuing until the start of the third ridge 528 at a bearing of 175 degrees.

The heating element 402 may be initially oriented such that the second electrical terminal 410 points towards a bearing of approximately 45 degrees. Thus, in this position, the heating element 402 is able to rotate substantially freely, or without much resistance, in either direction by around 40 degrees before encountering substantial resistance to rotation from one of the ridges. This may be referred to as a stable orientation because rotation of the heating element 402 relative to the heating element mount 522 by more than a predetermined angle is resisted. Thus, in this embodiment, the heating element 402 is locatable in four stable orientations—each of the four orientations in which the second electrical terminal contact portion 418 is between a different pair of adjacent ridges of the second electrical contact surface 510.

When in the stable orientation outlined above, if the heating element 402 is rotated clockwise by 40 degrees to a bearing of 85 degrees, for example under the application of a torque to the heating element 402, then the second electrical terminal contact portion 418 of the second electrical terminal 410 will engage with the second ridge 526. As the heating element 402 is rotated further clockwise under the application of a torque to the heating element 402, the resistance against rotation of the heating element 402, which is provided by the interaction between the second electrical terminal 418 and the second ridge 526, will also increase. This is because a greater torque is required to continue rotating the heating element 402 clockwise as the second electrical terminal 410 moves up towards the peak of the second ridge 526 located at a bearing of 90 degrees. This is because, during this continued rotation, the second electrical terminal 410 is forced to flex further from its natural, lowest-energy state.

Once the second electrical terminal 410 reaches the peak of the electrical ridge 526 at a bearing of 90 degrees under a torque applied to the heating element 402, the resistance to rotation of the heating element 402 decreases. This is because further clockwise rotation of the heating element 402 results in the second electrical terminal 410 moving down the second ridge 526 away from its peak. Thus, at this point, the heating element 402 is allowed to rotate, or can easily rotate, as the second electrical terminal 410 moves down beyond the peak of the second ridge 526 without much, if any, resistance. The peak torque applied to the heating element 402 is applied as the second electrical terminal 410 reaches the peak of the ridge and may be referred to as a threshold torque. Thus, beyond the applied threshold torque, the resistance to rotation of the heating element 402 decreases and the heating element 402 is allowed to rotate. In this manner, the aerosol-generating device 300 of FIG. 1 may be described as having a rotation resistance mechanism. The rotation resistance mechanism does not prevent the heating element 402 from being rotated indefinitely in a given direction, but will, in some orientations, offer resistance to rotation up to a threshold torque which may be termed a non-linear resistance to rotation. The rotation resistance mechanism resists rotation of the heating element in both directions, clockwise and anti-clockwise, in a similar manner.

FIG. 4 shows a cross-sectional view of an alternative aerosol-generating device 600 comprising an alternative heater assembly 700 and an alternative aerosol-generating device body 800.

The alternative aerosol-generating device 600 is similar to the aerosol-generating device 300 shown in FIG. 1 and so, only the key differences between the two devices are described here.

The heater assembly 700 is releasably coupled to the aerosol-generating device body 800 by mating a screw thread 702 of the heater assembly 700 with a corresponding screw thread 802 of the device body 800.

The heater assembly 700 comprises a heating element 704 and a body portion 706 but, unlike the heater assembly shown in FIG. 2, the heating element 704 is not fixed to the body portion 706. Rather, the heating element 704 is rotatably coupled to the body portion 706 using a spindle 708. The spindle 708 is attached to a blade 710 of the heating element 704 and rotatably coupled to a base of the main body 706. In this embodiment, the base of the main body 706 may be referred to as the heating element mount 712. Thus, in this embodiment, the heating element mount 712 is part of the heater assembly 700 and the heating element 704 is rotatably coupled to the heating element mount 712.

The heater assembly 700 also comprises an arm 714. The arm 714 extends radially outwardly and is coupled to the heating element 704 via the spindle 708 so as to rotate as the heating element 704 rotates. The arm 714 is located an annular recess 716 of the body portion 706. The annular recess 716 comprises four ridges extending radially inwardly. Each of the four ridges are equally spaced from each other and, when viewing the aerosol-generating device from above, are located with their radially-inward peaks at bearings of 0, 90, 180, and 270 degrees measured clockwise from the peak of the first ridge, similarly to the ridges of the aerosol-generating device of FIG. 1. In the cross-sectional view of FIG. 4, only the second ridge 718 and the fourth ridge 720 of the aerosol-generating device 600 can be seen.

As the heating element 704 rotates, the arm 714 rotates within the recess 716. As the heating element 704 rotates, the radially outer end of the arm 714 may contact one of the four ridges. The contacted ridge will resist further rotation of the heating element 704 in a similar way to that described in relation to the ridges of the aerosol-generating device shown in FIG. 1. That is, after the radially outer end of the arm 714 has moved towards and contacted the beginning of a ridge, the arm 714 will have to flex further from its natural, lowest-energy state in order for the arm 714 to travel along the ridge towards its peak and in order for the heating element 704 to be rotated further. Thus, the ridge is providing resistance against further rotation of the heating element 704, this resistance increasing as a torque applied to the heating element 704 increases. Once the arm 714 reaches the peak of the ridge, the resistance to further rotation decreases. This is because further rotation of the heating element 704 results in the radially-extending arm 714 moving down the ridge away from its peak. Thus, at this point, the heating element 704 is allowed to rotate without much, if any, resistance. The peak torque applied to the heating element is applied as the arm 714 reaches the peak of the ridge and may be referred to as a threshold torque. Thus, when the torque applied to the heating element 704 surpasses the threshold torque, the resistance to rotation of the heating element 704 decreases and the heating element 704 is allowed to rotate. In this manner, the heater assembly 700 of the aerosol-generating device 600 of FIG. 4 may be described as having a heater assembly rotation resistance mechanism. The heater assembly rotation resistance mechanism does not prevent the heating element 704 from being rotated indefinitely in a given direction relative to the heating element mount 712 of the heater assembly 700, but will, in some orientations, offer resistance to rotation up to a threshold torque. This may be termed a non-linear resistance to rotation. The heater assembly rotation resistance mechanism resists rotation of the heating element 704 in both directions, clockwise and anti-clockwise, in a similar manner.

In the embodiment shown in FIG. 4, the second electrical contact surface 804 of the aerosol-generating device body 800 is a substantially flat, annular loop of electrically conductive material. There are no ridges in this second electrical contact surface 804 as the rotation to resistance of the heating element 704 is provided by the heater assembly rotation resistance mechanism described above.

Operation of the aerosol-generating device 600 to generate an aerosol from an aerosol-generating article (not shown in FIG. 4) is identical to operation of the aerosol-generating device 300 shown in FIG. 1.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-19. (canceled)

20. A heater assembly couplable to an aerosol-generating device body to form an aerosol-generating device, the heater assembly comprising:
a heating element mount;
a heating element rotatably coupled to the heating element mount and configured to penetrate an aerosol-generating article; and
a heater assembly rotation resistance mechanism configured to
resist rotation of the heating element in a first direction relative to the heating element mount,
limit rotation of the heating element in the first direction relative to the heating element mount up to a threshold torque applied to the heating element, and
allow further rotation of the heating element when a torque applied to the heating element exceeds the threshold torque.

21. The heater assembly according to claim 20, wherein the heater assembly rotation resistance mechanism is further configured to resist rotation of the heating element in a second direction, opposite to the first direction, relative to the heating element mount.

22. An aerosol-generating device, comprising:
an aerosol-generating device body and a heater assembly coupled to the aerosol-generating device body, wherein the heater assembly comprises a heating element configured to penetrate an aerosol-generating article and to rotate relative to a heating element mount of the aerosol-generating device; and
a rotation resistance mechanism configured to
resist rotation of the heating element in a first direction relative to the heating element mount,
limit rotation of the heating element in the first direction relative to the heating element mount up to a threshold torque applied to the heating element, and
allow further rotation of the heating element when a torque applied to the heating element exceeds the threshold torque.

23. The aerosol-generating device according to claim 22, wherein the rotation resistance mechanism is further configured to resist rotation of the heating element in a second direction, opposite to the first direction, relative to the heating element mount.

24. The aerosol-generating device according to claim 22, wherein the heater assembly further comprises a rotary electrical interface and the aerosol-generating device body comprises a power supply and a second rotary electrical interface corresponding to the rotary electrical interface, the rotary electrical interface and the second rotary electrical interface together forming a rotary electrical connection configured to connect the heating element to the power supply.

25. The aerosol-generating device according to claim 24,
wherein the heating element comprises an electrically resistive track through which a current is passed in use to increase a temperature of the electrically resistive track,
wherein the electrically resistive track has a first electrical terminal and a second electrical terminal, and
wherein the rotary electrical interface comprises the first electrical terminal and the second electrical terminal, and the second rotary electrical interface comprises a first electrical contact surface in contact with the first electrical terminal, and a second electrical contact surface in contact with the second electrical terminal.

26. The aerosol-generating device according to claim 25, wherein the second electrical contact surface is spaced from, and encircles, the first electrical contact surface.

27. The aerosol-generating device according to claim 22, wherein the aerosol-generating device body comprises at least a portion of the rotation resistance mechanism.

28. The aerosol-generating device according to claim 24, wherein the rotary electrical connection comprises at least a portion of the rotation resistance mechanism.

29. The aerosol-generating device according to claim 22, wherein the heater assembly is releasably couplable to the aerosol-generating device body.

30. The heater assembly according to claim 20, wherein the heating element comprises a substantially flat blade.

31. The aerosol-generating device according to claim 22, wherein the heating element comprises a substantially flat blade.

32. The heater assembly according to claim 20, wherein the heating element is configured to rotate at least 360 degrees in the first direction.

33. The aerosol-generating device according to claim 22, wherein the heating element is configured to rotate at least 360 degrees in the first direction.

34. The heater assembly according to claim 32, wherein the heating element is further configured to rotate indefinitely in the first direction.

35. The aerosol-generating device according to claim 33, wherein the heating element is further configured to rotate indefinitely in the first direction.

36. The heater assembly according to claim 20, wherein the heating element is rotatable in both the first direction and a second direction opposite to the first direction, relative to the heating element mount.

37. The aerosol-generating device according to claim 22, wherein the heating element is rotatable in both the first direction and a second direction opposite to the first direction, relative to the heating element mount.

38. The heater assembly according to claim 36, wherein the heating element is further configured to rotate indefinitely in the second direction.

39. The aerosol-generating device according to claim 37, wherein the heating element is further configured to rotate indefinitely in the second direction.

40. The heater assembly according to claim 20, wherein the heating element is rotatable relative to the heating element mount between at least two stable orientations.

41. The aerosol-generating device according to claim 22, wherein the heating element is rotatable relative to the heating element mount between at least two stable orientations.

42. The heater assembly according to claim 40, wherein, in at least one of the at least two stable orientations, rotation of the heating element relative to the heating element mount by less than a first predetermined angle in the first direction is substantially unresisted.

43. The aerosol-generating device according to claim 41, wherein, in at least one of the at least two stable orientations, rotation of the heating element relative to the heating element mount by less than a first predetermined angle in the first direction is substantially unresisted.

44. The heater assembly according to claim 40, further comprising a first biasing means for biasing the heating element towards a first stable orientation of the at least two stable orientations.

45. The aerosol-generating device according to claim 41, further comprising a first biasing means for biasing the heating element towards a first stable orientation of the at least two stable orientations.

46. The heater assembly according to claim 20, wherein the threshold torque is between 0.0129 Newton metres and 8.050 Newton metres.

47. The aerosol-generating device according to claim 22, wherein the threshold torque is between 0.0129 Newton metres and 8.050 Newton metres.
